(19) United States
(12) Patent Application Publication
(10) Pub. No.: US 2008/0089338 A1
(43) Pub. Date: Apr. 17, 2008

(54) Methods for remotely creating and managing virtual machines

(76) Inventors: Robert Campbell, Cupertino, CA (US); Carol Bassett, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/581,105

(22) Filed: Oct. 13, 2006

(51) Int. Cl. H04L 12/56

(52) U.S. Cl. 370/392; 370/401

(57) ABSTRACT

A method for managing from a remote terminal a virtual machine, which represents one of a plurality of virtual machines implemented on a hardware platform that is communicably coupled to the remote terminal via a computer network, is provided. Each virtual machine is associated with a MAC address of a plurality of MAC addresses associated with the hardware platform. The method includes receiving, using a network interface card (NIC) associated with the hardware platform, from the remote terminal a management packet, which represents a data packet having at least a first MAC address and an action (e.g., wake up or shut-down) for the virtual machine. The management packet is forwarded to a NIC manager, which ascertains whether the first MAC address matches one of the plurality of MAC addresses associated with the hardware platform. If a match is identified, the action for the virtual machine is performed.

### BACKGROUND OF THE INVENTION

Advances in technology have proliferated computer usage. Today, computer systems have become an integral part of everyday life. As modern society becomes more dependent upon computer systems, a growing need for the ability to remotely access computer systems in order to give users the ability and flexibility to manage their technological environment has arisen.

The computer industry has a plurality of tools that may be employed to automate the management of the information technology infrastructure. In an example, tools are available to automate the initiation and configuration of operating systems. However, automated installed tool may not perform properly if a computer system is not powered on.

Generally, a physical computer is powered off to conserve resources when the physical computer is not active. To power on a physical computer, a user may easily push the power-on button. However, a user may not always want to physically push a button to power on and/or power off a physical computer, especially if a user is responsible for managing a plurality of computer systems within a network. In addition, the user may not want to keep track of a complex schedule of when different physical computers may need to be powered on and/or off. Wake-On-LAN is an industry standard that may be employed in remotely powering on and/or powering off a physical computer. Wake-On-Lan is a software that is independent of an operating system. Basically, the Wake-On-Lan is equivalent to pushing the power button.

To facilitate discussion, FIG. 1 shows a simple block diagram of a physical computer being awaken remotely through a network connection. A computer management system 102 is a management console in a data center. Computer management system 102 may be continuously running scripts 102a ensuring that actions (e.g., scheduled events, pre-programmed actions, actions due to certain conditions, diagnostic, etc.) are occurring.

Consider the situation wherein, for example, a computer system 112 has to perform backup every night at midnight. When conditions of the scheduled event have been met, script 102a may format a data packet 104 to be broadcast to the other computer systems (106, 112, and 122) on a network 124. Data packet 104, which may include Media Access Control (MAC) address 104a, command 104b (e.g., power on command), and other instructions 104c. Data packet 104 may be sent via network 124 to each of the ports on the network. In other words, each of the computer systems (106, 112, and 122) may receive data packet 104.

If a computer system is currently on, such as computer system 106, and receives packet 104, computer system 106 may ignore packet 104. Since computer system 106 is already powered-on, a packet monitoring 110 within a network interface card (NIC) 108 may not be actively searching for a packet, such as packet 104.

If a computer system is currently off, such as computer systems 112 and 122, the physical computer may have sufficient standby power that may enable a NIC to monitor wake packet. Upon receiving the wake packet, the NIC may analyze the wake packet. In an example, a NIC 120 on computer system 122 receives packet 104. A packet monitoring 118 within NIC 120 compares MAC address 104a against the MAC address for computer system 122. If the two MAC addresses do not match then computer system 122 remain inactive.

In another example, a NIC 114 on computer system 112 receives packet 104. A packet monitoring 116 within NIC 114 compares MAC address 104a against the MAC address for computer system 112. Since the two MAC addresses match, computer system 112 is powered on and may begin its scheduled event.

By being able to remotely control the activities of physical computers, resource management may be performed. Another method of managing resources is by creating virtual machines on a physical computer. For a single physical computer, a plurality of virtual machines may be created. As discussed herein, a virtual machine is a software construct with a guest operating system that may exist on an actual physical computer. Virtual machines may be created in an attempt to maximize and balance the resources available in a physical computer. Generally, a virtual machine does not have to remain on once the virtual machine has completed its task. Instead better load balancing may be performed if the resources could be allocated elsewhere.

Unfortunately, virtual machines may be created from different proprietary software which may include specific rules about how a virtual machine may behave. Thus, each virtual machine may have unique behavior for its operating system. Due to the variability of proprietary software that may be employed to create virtual machines, the standard automation tool that may be employed to power on/off a physical computer may not be able to communicate with the plurality of proprietary software. As a result, the ability to remotely access virtual machines has not been feasible without reconfiguring the host physical computer.

FIG. 2 shows a simple block diagram of a plurality of virtual machines on a physical machine. A physical computer 246 may include a CPU 226 and a memory 228. Physical computer 246 may also include a user interface input/output 230 from which keyboard, mouse, video, etc. may be connected. Further, physical computer 246 may include a disk 232 which may have a disk drive 236 (e.g., any network attached storage space). In addition, physical computer 246 may also include a NIC 234, which may be connected to a network 238.

Physical computer 246 may also include a host operating system 248, which may be responsible for starting virtual machines (e.g., 220, 222, and 224). Host operating system 248 may include servers (240, 242, and 244) to provide access to physical computer 246. In an example, user interface input/output manager 240 may provide virtual machines (220, 222, and 224) with access to user interface input/output 230 on physical computer 246. In another example, disk manager 242 may provide virtual machines (220, 222, and 224) with access to disk 232 on physical computer 246. In yet another example, NIC manager 244 may provide virtual machines (220, 222, and 224) with access to NIC 234 of physical computer 246.

Virtual machines 220, 222, and 224 are software constructs which may have virtual devices. In an example, virtual machine 220 may have a virtual CPU 210, a virtual memory 212, a virtual user interface input/output 214, a virtual disk 216, and a virtual NIC 218. In addition, each virtual machine may have independent operating system. In an example, virtual machine 220 may have a guest operating system 204, virtual machine 222 may have a guest operating system 206, and virtual machine 224 may have a guest operating system 208.

Consider the situation wherein, for example, virtual machine 220 is asleep and a wake packet with a power on command for virtual machine 220 is sent. If physical computer 246 is currently on, NIC 234 may ignore the packet; thus, virtual machine 220 may never receive the command to power on since physical computer is already powered on. If physical computer 246 is currently off, NIC 234 may compare the incoming wake packet with the MAC address of the physical computer 246. Since the wake packet, in this example, may include the MAC address for virtual machine 220, NIC 234 may not find a match and the wake packet is ignored. In order for virtual machine 220 to receive this wake packet, the script may have to be tailored to accommodate the proprietary software that may be associated with the virtual machine.

As illustrated by FIG. 2, a remote method for power on/off virtual machines may not be available. Instead, some virtual machines may only be accessible if a user interacts with a proprietary tool interface to power on/off the virtual machines. In some circumstances the script for powering on physical machines may have to be rewritten or reconfigured in order to accommodate the proprietary software that may be associated with each virtual machine.

### SUMMARY OF INVENTION

The invention relates, in an embodiment, to a method for remotely managing a virtual machine from a remote terminal, the virtual machine representing one of a plurality of virtual machines implemented on a hardware platform that is communicably coupled to the remote terminal via a computer network. Each of the plurality of virtual machines is associated with a MAC (Media Access Controller) address of a plurality of MAC addresses associated with the hardware platform. The remotely managing is one of a wake action and a shut-down action. The method includes receiving, using a network interface card (NIC) associated with the hardware platform, a management packet from the remote terminal. The management packet represents a data packet having therein at least a first MAC address. The management packet represents one of a wake packet for waking up the one of the plurality of virtual machines and a shut-down packet for shutting down a virtual machine that is associated with the first MAC address. The method also includes forwarding the management packet to a NIC manager that is executing on the hardware platform. The method further includes ascertaining, using the NIC manager, whether the first MAC address matches one of the plurality of MAC addresses associated with the hardware platform. The method yet also includes, if the first MAC address matches the one of the plurality of MAC addresses, performing one of the wake action and the shut-down action for the virtual machine that is associated with the first MAC address. The wake action is performed if the management packet represents the wake packet. The shut-down action is performed if the management packet represents the shut-down packet.

In another embodiment, the invention relates to a method for remotely creating a virtual machine from a remote terminal, the remote terminal being communicably coupled to a plurality of computers via a computer network. The method includes receiving, using a network interface card (NIC) associated with a first one of the plurality of computers, a wake-up packet from the remote terminal. The wake-up packet represents a data packet having therein at least a first MAC address. The method includes forwarding the management packet to a NIC manager that is executing on the first one of the plurality of computers. The method also includes ascertaining, using the NIC manager, whether the first MAC address matches one of a plurality of MAC addresses associated with the one of the plurality of computers. The method further includes, if the first MAC address matches the one of the plurality of MAC addresses and an already-created virtual machine that is associated with the first MAC address does not exist, employing an operating system of the first one of the plurality of computers to create the virtual machine in accordance with a virtual machine specification that is associated with at least one of the first MAC address and a sub-range of the plurality of MAC addresses.

In yet another embodiment, the invention relates to a method for remotely creating a virtual machine from a remote terminal, the remote terminal being communicably coupled to a plurality of computers via a computer network. The method includes receiving, using a network interface card (NIC) associated with a first one of the plurality of computers, a wake-up packet from the remote terminal. The wake-up packet represents a data packet having therein at least a first MAC address. The method includes forwarding the management packet to a NIC manager that is executing on the first one of the plurality of computers. The method also includes ascertaining, using the NIC manager, whether the first MAC address is found in one of a plurality of MAC address sub-ranges associated with the one of the plurality of computers. The method further includes, if the first MAC address is found in the one of a plurality of MAC address sub-ranges and an already-created virtual machine that is associated with the first MAC address does not exist, employing an operating system of the first one of the plurality of computers to create the virtual machine in accordance with a virtual machine specification that is associated with the one of a plurality of MAC address sub-ranges, wherein each of the plurality of MAC address sub-ranges is associated with a different virtual machine specification.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple block diagram of a physical computer being awaken remotely through a network connection.

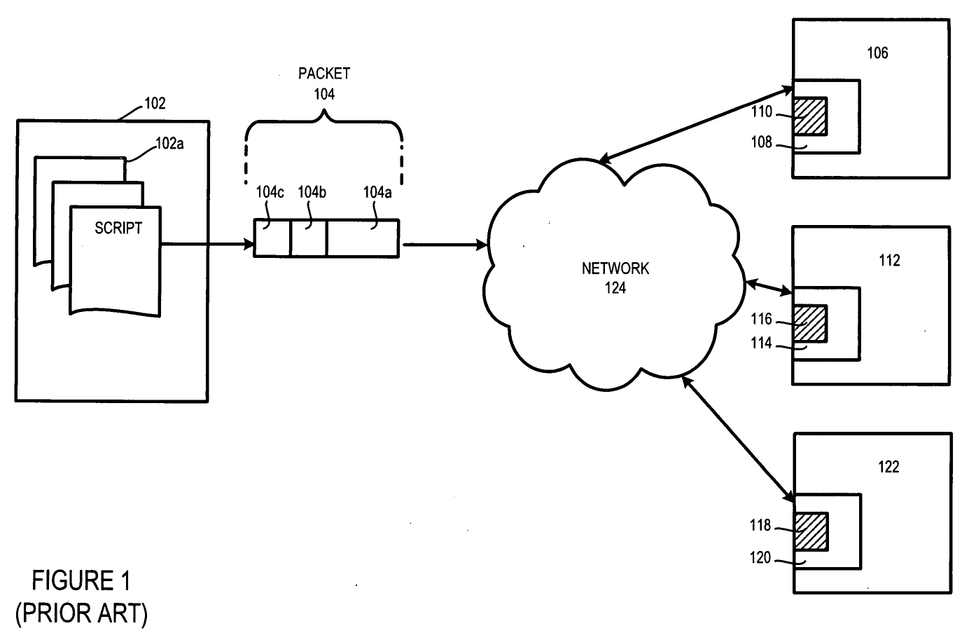

FIG. 2 shows a simple block diagram of a plurality of virtual machines on a physical machine.

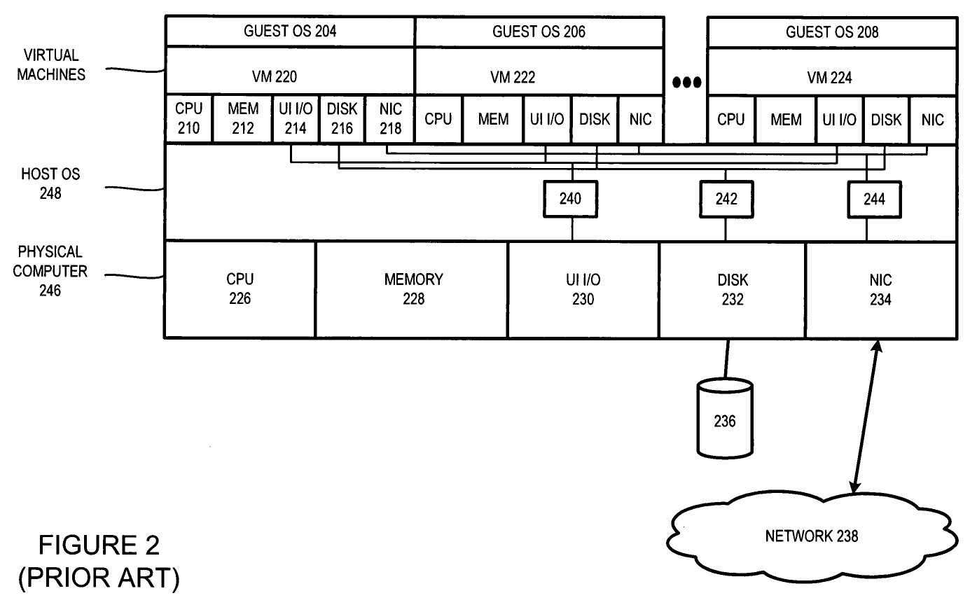

FIG. 3A shows, in an embodiment, an example of simple block diagram illustrating a remote method for managing a virtual machine that is not currently powered on.

FIG. 3B shows, in an embodiment, a flow chart illustrating how a virtual machine may be remotely powered on.

FIG. 4A shows, in an embodiment, an example of simple block diagram illustrating a remote method for managing a virtual machine that is currently powered on.

FIG. 4B shows, in an embodiment, a flow chart illustrating how a virtual machine may be remotely powered off.

FIG. 5 shows an example of a flow chart illustrating the process for setting up a new virtual machine.

FIG. 6 shows, in an embodiment, an example of a flow chart for creating a new virtual machine remotely.

### DETAILED DESCRIPTION OF VARIOUS EMBODIMENTS

The present invention will now be described in detail with reference to various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

In accordance with one aspect of the present invention, the inventors herein realized that the wake and/or shut-down packets may not have been accessible to the virtual machines because the NIC of a physical computer may have filtered out packets that may not have the physical computer MAC address. The NIC of the physical computer may have access to only the physical computer MAC address; however, the host operating system may have full knowledge of a range of MAC addresses that may be associated with the physical computer. Thus, the host operating system may be able to identify the MAC address with the virtual machine that may be associated with the MAC address in the wake/shut-down packets. Accordingly, the inventors herein realized that the filtering may be redirected from the NIC to the host operating system of the physical computer, thereby, enabling the host operating system to perform a better comparison between the MAC address within the wake/shut-down packets and the list of MAC addresses.

In accordance with embodiments of the present invention, there is provided a computer-implemented method for remotely creating and managing virtual machines. In embodiments of the invention, a virtual machine may be remotely powered on by redirecting the decision-making power from a network interface card (NIC) of a physical computer to a host operating system of the physical computer. Also, embodiments of the invention enable a virtual machine to be created remotely by employing industry standard rapid deployment tools.

In an embodiment of the invention, a wake packet may be sent to power on a virtual machine. As discussed herein, a wake packet refers to a special network packet that may include the MAC address of the computer (e.g., physical computer, virtual machine) being powered on.

As discussed herein, MAC address refers to a unique identification number that identifies a computer (e.g., physical computer, virtual machine). Each physical computer may be identified by a specific MAC address. In addition, each physical computer may be associated with a range of MAC addresses, which may enable the physical machine to provide unique identifier for each virtual machine that may be hosted by a physical computer.

Virtual machines are generally “powered off” when the virtual machines are not performing a task to conserve resources for a physical computer. Upon receiving the wake packet, the NIC of a physical computer may forward the wake packet to a NIC manager in the host operating system, in an embodiment. As discussed herein, a NIC manager refers to an application responsible for managing MAC addresses for a physical computer.

In an embodiment, the wake packet is analyzed by the NIC manager within a host operating system instead of by the NIC, which may only know the MAC address of the physical computer. Unlike the NIC, the NIC manager has access to the complete list of MAC addresses associated with the physical computer. Thus, the NIC manager is able to compare the MAC address on the incoming wake packet against the range of acceptable MAC addresses to determine a match. If a match is identified by the NIC manager, then the NIC manager may request the host operating system to power on the virtual machine, in an embodiment.

Similarly, a virtual machine that is no longer active (e.g., one that has completed its task) may be powered off remotely to conserve the physical computer resources. In an embodiment, a shut-down packet may be sent remotely to power off a virtual machine. As discussed herein, a shut-down packet refers to a special network packet that may include the MAC address of the computer (e.g., physical computer, virtual machine) being powered off. The term shut-down includes, but are not limited to, hibernate, power off, and reboot the system.

A shut-down packet may be received by a NIC of a physical computer and may be forwarded to a NIC manager in the host operating system, in an embodiment. The NIC manager, in an embodiment, may act as a network switch by broadcasting the shut-down packet to all virtual machines on the physical computer. The comparison of the MAC address may be performed by each of the NIC of the virtual machines. In an example, the NIC of virtual machine 1 may compare the MAC address on the shut-down packet against the MAC address of the virtual machine 1. If a match is not identified, then the NIC of virtual machine 1 may discard the shut-down packet. However, if a match is identified, then the NIC of virtual machine 1 may power down virtual machine 1.

In another embodiment, the NIC manager may analyze the MAC address of the incoming shut-down packet against a list of acceptable ranges of MAC addresses. Once a match has been identified, the NIC manager may also know which virtual machine to notify. In an embodiment, instead of broadcasting the shut-down packet to all of the virtual machines, the NIC manager may only send the shut-down packet to the virtual machine associated with the MAC address on the shut-down packet.

In an embodiment of the invention, virtual machines may also be created remotely. Consider the situation, wherein, for example, a new virtual machine needs to be created. Instead of having a human operator manually decides which physical computer may best host the new virtual machine, the human operator may employ a rapid deployment server to analyze the network to determine which physical computer of the entire network may best host the new virtual machine. In addition, experts may be employed to pre-program the RDP and the various physical computers to define the parameters of a virtual machine based on roles assigned to the virtual machine. This method of pre-programming the system removes the necessity of being dependent upon a skilled operator to create a new virtual machine. Instead, a skilled/unskilled user may request for a new virtual machine by defining the role of the new virtual machine. Once the role has been assigned, the new virtual machine may be created without further human interference.

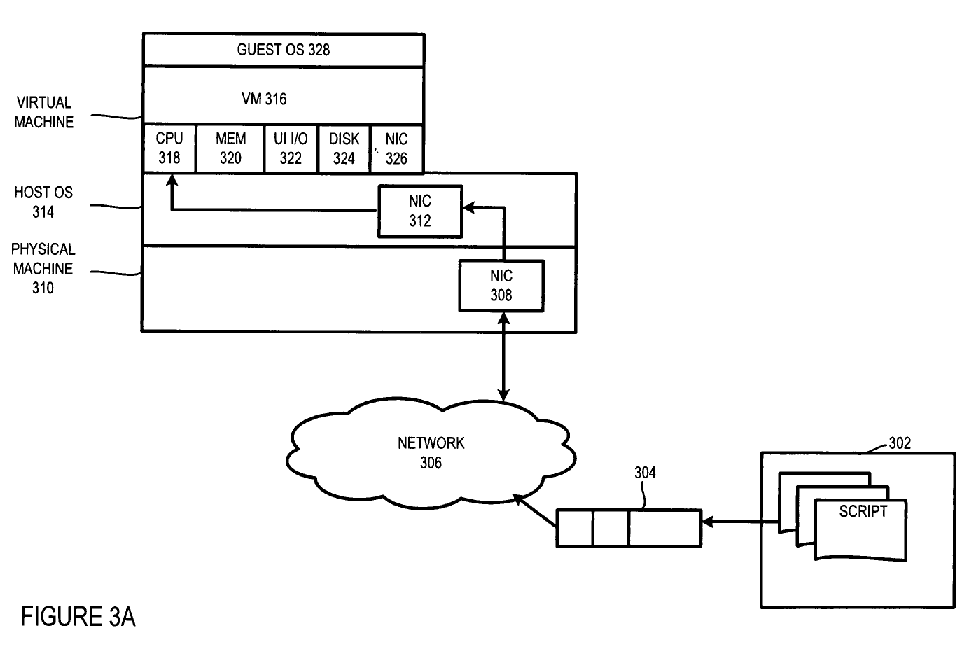

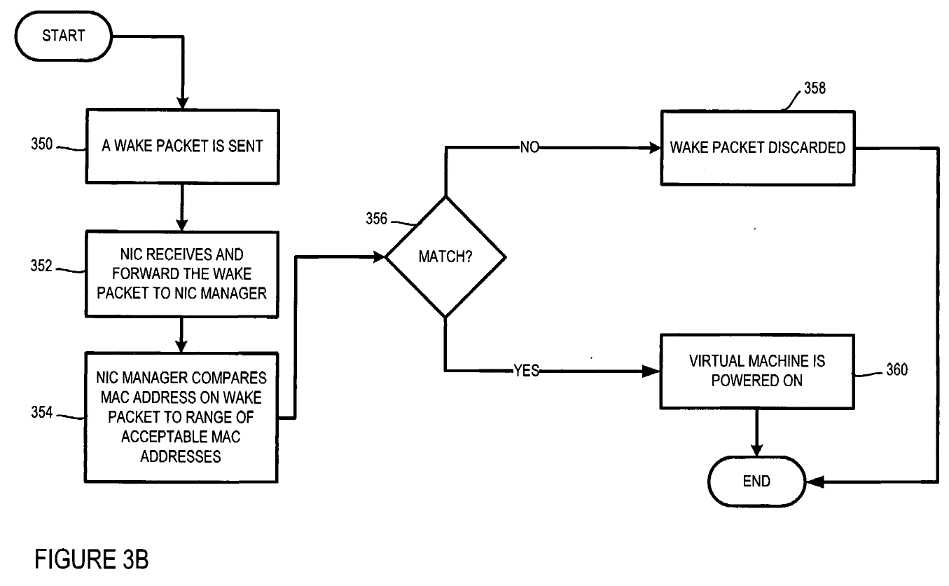

The features and advantages of the invention may be better understood with reference to the figures and discussions that follow. FIG. 3A shows, in an embodiment, an example of a simple block diagram illustrating a remote method for managing a virtual machine that is not currently powered on. FIG. 3A will be discussed in relation to FIG. 3B. FIG. 3B shows, in an embodiment, a flow chart illustrating how a virtual machine may be remotely powered on.

Consider the situation wherein, for example, a virtual machine needs to be powered on. At a first step 350, a wake packet 304 with a command to power on a virtual machine may be sent by a computer monitoring system 302 via a network 306 to a NIC 308 in a physical computer 310. Unlike the prior art, NIC 308 may not analyze wake packet 304, at a next step 352. Instead, NIC 308 may forward wake packet 304 to a NIC manager 312 located within a host operating system 314.

Upon receiving wake packet 304, at a next step 354, NIC manager 312 may compare the MAC address within wake packet 304 with a list of acceptable MAC address ranges. For each physical computer, a range of MAC addresses may be assigned. As a virtual machine is created, a MAC address may be assigned to the virtual machine. One of NIC manager 312 roles may be to manage the list of MAC addresses. Another role of NIC manager 312 may be to manage the incoming packet.

In an example, upon receiving wake packet 304, NIC manager 312 may compare the MAC address in wake packet 304 against a list of acceptable MAC address range for physical computer 310. At a next step 356, a match may be determined. If a match is not identified, then wake packet 304 may be discarded, at a next step 358. However, if the MAC address on wake packet 304 matches with one of the MAC address in physical computer's range of MAC addresses, then NIC manager 312 may powered on the virtual machine, at a next step 360. In this example, the MAC address in wake packet 304 matches with the MAC address for virtual machine 316, thereby, NIC manager 312 informs host operating system 314 to power on virtual machine 316. If the virtual machine is already powered on, then no action may need to be performed. Once virtual machine 316 is powered on, virtual machine 316 may begin to build the software construct, including CPU 318, memory 320, user interface input/output 322, disk 324, and NIC 326.

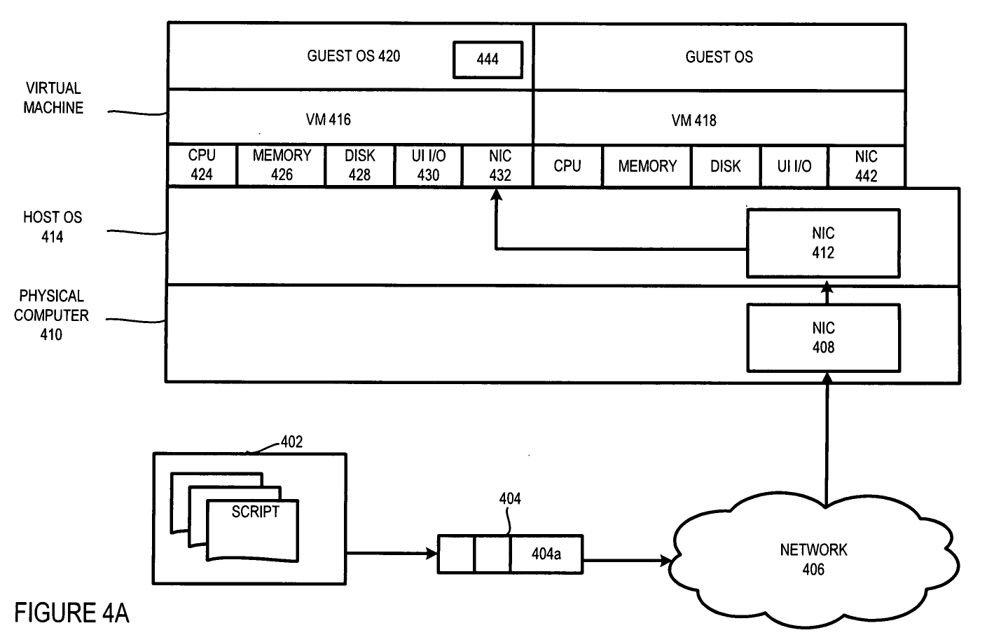

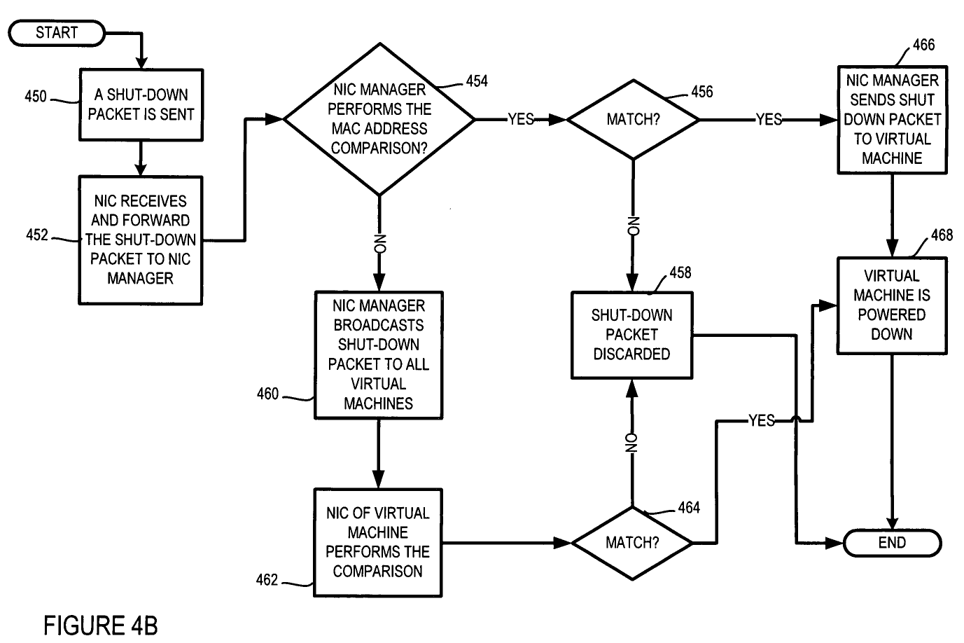

FIG. 4A shows, in an embodiment, an example of simple block diagram illustrating a remote method for managing a virtual machine that is currently powered on. FIG. 4A will be discussed in relation to FIG. 4B. FIG. 4B shows, in an embodiment, a flow chart illustrating how a virtual machine may be remotely powered off. This method enables a user to remotely shut down a virtual machine. The term shut down includes, but are not limited to, hibernating, powering off, and rebooting the system.

Consider the situation wherein, for example, a virtual machine needs to be powered down. At a first step 450, a shut-down packet 404 with a MAC address 404a with a command to power down a virtual machine may be sent by a computer monitoring system 402 via network 406 to a NIC 408 in a physical computer 410. Unlike the prior art, NIC 408 may not analyze shut-down packet 404. Instead, NIC 408 may forward shut-down packet 404 to a NIC manager 412 located within a host operating system 414, at a next step 452.

At a next step 454, NIC manager 412 may or may not perform the MAC address comparison. In an embodiment, NIC manager 412 may not perform a MAC address comparison. Instead, at a next step 460, NIC manager 412 may act as a network switch and may broadcast shut-down packet 404 to all of the virtual machines (416 and 418), in an embodiment.

At a next step 462, each NIC (432 and 442) of each of the virtual machines (416 and 418) may compare MAC address 404a against the MAC address of the virtual machine to determine a match. In an example, NIC 442 may compare MAC address 404a against MAC address of virtual machine 418. If at a next step 464, a match is not identified, then the shut-down packet may be discarded, at a next step 458. In an example, NIC 442 may discard shut-down packet 404 since a match has not been identified. If a match is identified, then the virtual machine may be powered down. In an example, NIC 432 may compare MAC address 404a against MAC address of a virtual machine 416 and identify a match. As a result, NIC 432 may perform the command within shut-down packet 404 (i.e., to power down virtual machine 416), at a next step 468

In an embodiment, instead of broadcasting shut-down packet 404 to all of the virtual machines, NIC manager 412 may compare the incoming MAC address 404a against a list of acceptable range of MAC addresses. Referring back to a next step 454, NIC manager may perform a MAC address comparison. At next step 456, NIC manager 412 may determine whether or not a match between the MAC address on the incoming shut-down packet 404 and the range of MAC addresses. If a match is not identified, then shut-down packet 404 is discarded, at next step 458. However, if NIC manager 412 identifies a match, then shut-down packet 404 may be sent directly to the virtual machine associated with MAC address 404a, at a next step 466.

At next step 468, the shut-down command is relayed to an operating system 420 of virtual machine 416. The shut-down command is analyzed and carried out by a power state manager 444 within operating system 420. Power state manager 444 may have an industry standard construct (e.g., advanced configuration power interface), which instruct operating system 420 to power down (which may include save, wash buffer to disc, exit, etc.). Once the operating system has powered down, then virtual machine 416 may begin tearing down the virtual devices (e.g., CPU 424, memory 426, user interface input/output 428, disk 430, and NIC 432) until virtual machine 416 no longer exist. In an embodiment, if the virtual machine does not have the required application to tear down the virtual devices, than NIC manager 412 may inform host operating system 414 that the deconstruction may have to be performed by host operating system 414.

As shown in FIGS. 3A, 3B, 4A, and 4B, the inventors herein realized, in an embodiment of the invention, that standard scripts, such as those that may be employed in remotely accessing and managing physical computer, may also be employed to manage a plurality of virtual machines. The methods show that by redirecting the decision-making power from a NIC to the host operating system of the physical computer, the plurality of virtual machines may be remotely accessed and managed. Thus, the computer-implemented methods do not require the script for managing the physical computer to be rewritten to accommodate the plurality of virtual machines. In addition, the computer-implemented method may also enable load balancing since the plurality of virtual machines may be powered on/off as needed.

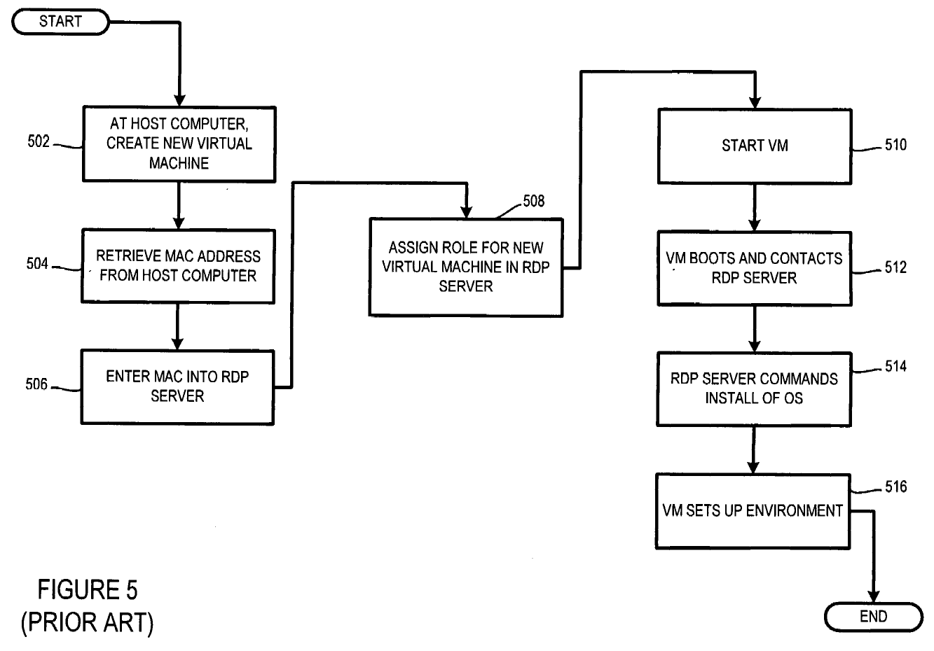

In the prior art, the process of setting up a new virtual machine is generally a manual process. In other words, a new virtual machine may not be set up remotely. Prior art FIG. 5 shows an example of a flow chart illustrating the process for setting up a new virtual machine. When a request for a new virtual machine is received by an operator, the operator at a first step 502 may begin the process of creating a new virtual machine. To create a new virtual machine, the operator may have to go to a physical machine upon which the new virtual machine will reside to access a virtual host interface. As discussed herein, a virtual host interface is an application in the host operating system of the physical machine that may manage virtual machines. The operator may have to provide instruction on how the virtual machine may need to be created. The information the operator may have to enter may include, but are not limited to the amount of CPU, the amount of memory space, the amount of disk space, the number of NICs.

At a next step 504, the operator may have to interact with the virtual host interface to extract the MAC address that has been assigned to the newly created virtual machine. At a next step 506, the operator may proceed to a rapid deployment pack (RDP) server to enter in the MAC address for the newly created virtual machine. In addition, at a next step 508, the operator may have to define the role of the new virtual machine to the RDP.

Generally, a RDP server has been used in the prior art as a mean of powering on physical machines that may not have been properly configured to boot up. Consider the situation wherein, for example, a physical machine may have been received, placed on a rack in a data center, and plugged into an electrical outlet. However, no configuration has yet been performed on the physical machine. By using an RDP server, an operator may send a power-on packet to a NIC on the physical machine. Upon receiving this packet, the physical machine is powered on; however, the physical machine may be unable to boot up since the boot information has not been provided to the physical machine yet. Instead, the physical machine may broadcast a message requesting for boot information. The RDP server may receive the packet and send the boot information to the new physical machine.

Similarly, the RDP server may be employed in booting a newly created virtual machine. At a next step 510, the operator may manually power on the newly created virtual machine. Upon waking up, at a next step 512, the newly created virtual machine may employ a pre-executable environment boot (PXE). In other words, the virtual machine may request for boot information by broadcasting a trivial file transfer protocol (TFTP) request, which may include the MAC address associated with the newly created virtual machine. Upon receiving this packet, at a next step 514, the RDP server may recognize the MAC address and respond to the TFTP request by sending boot information to the new virtual machine. At a next step 516, upon receiving the boot information, the virtual machine may begin setting up its environment (e.g., parameters for the virtual machine, tools, operating system, applications for the designated role).

There are several disadvantages to the prior art method of creating a new virtual machine. First, the method may usually require manual intervention by a human operator. In other words, the human operator may have to physically interact with the physical computer that will be hosting the new virtual machine. Also, the method may require the human operator to have expert knowledge of creating the different types of virtual machines that may be requested. In other words, the human operator may need to have the required knowledge to create the requested new virtual machine. In an example, the human operator may have to know the parameters that may have to be supplied to the RDP server such that the RDP server may later send the code that may set up the correct environment for the new virtual machine. The manual intervention and the requirement for skilled human operator may present many opportunities for erroneous entries.

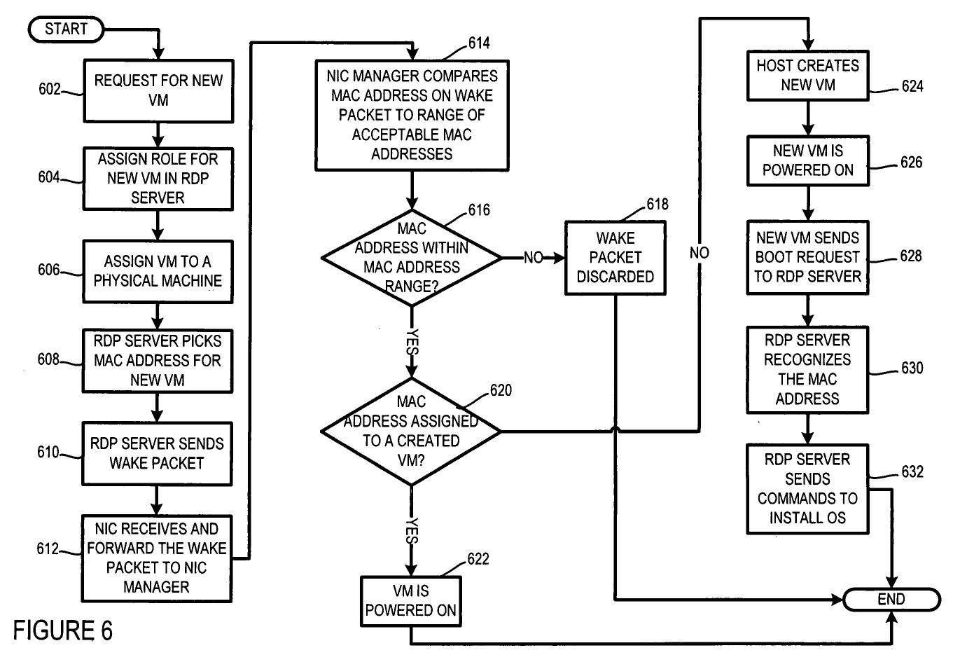

FIG. 6 shows, in an embodiment, an example of a flow chart for creating a new virtual machine remotely. At a first step 602, a human operator may request for a new virtual machine by accessing a RDP server. At a next step 604, the human operator may employ the RDP server to define the role of the new virtual machine. With this method, the human operator does not have to interact with any specific physical machine. Instead, once the RDP server has received the request and the role for the new virtual machine, at a next step 606, the RDP server may assign the new virtual machine to a physical machine based on the availability of each physical machine on the network and the requirement of the virtual machine based on the assigned role. In an example, the role of the new virtual machine requires a physical computer with a large amount of memory space. The RDP server may analyze each physical computer and assign the virtual machine to the physical computer that may best accommodate the role of the new virtual machine. By having the RDP server handle the distribution of the virtual machine, a better utilization of the network resources may be enabled. Further, the human operator does not have to do preliminary work to determine which physical computer may best accommodate the new virtual machine.

Once the virtual machine has been assigned to a physical computer, at a next step 608, the RDP server may assign an unused MAC address to the new virtual machine. In an embodiment, the MAC address may be randomly assigned from a range of MAC addresses that is specific to a physical computer. In another embodiment, a physical computer may have divided its range of MAC addresses into sub-ranges. Each sub-range of MAC address may have different parameters for the creation of virtual machine.

At a next step 610, the RDP server may send a wake packet. In an embodiment, the RDP server may broadcast the wake packet to all the physical computers on the network. In another embodiment, the RDP server may only send the wake packet to a specific physical computer, given that the RDP server has knowledge of the association between physical computers and ranges of MAC addresses.

Upon receiving the wake packet, at a next step 612, the NIC of the host operating system of the physical computer may pass the wake packet to the NIC manager. At a next step 614, the NIC manager may compare the incoming MAC address on the wake packet against a list of MAC addresses that may be associated with the physical computer. At a next step 616, if the MAC address is not within range, then at a next step 618, the wake packet may be discarded. However, if the MAC address is within range, then at a next step 620, the NIC manager may determine if the MAC address of the wake packet is associated with a virtual machine. If the MAC address is associated with a current virtual machine, then at a next step 622, the NIC manager may inform the host operating system to power on the virtual machine. However, if the MAC address is not associated with a current virtual machine, then at a next step 624, the host operating system may create a new virtual machine.

In an embodiment, the new virtual machine may be built according to a default setting. In another embodiment, the new virtual machine may be created according to parameters defined for a sub-range of MAC addresses. As mentioned at a next step 608, the range of MAC addresses on a physical computer may have been segmented into small sub-ranges. Each sub-range may provide different parameters for creating new virtual machines. In an example, the range of MAC addresses has been divided into three sub-ranges. Virtual machine with MAC addresses within the first sub-range may be built with default parameters. Virtual machine with MAC addresses within the second sub-range may be built with less memory requirements than the default requirements. Virtual machine with MAC addresses within the third sub-range may be built with more memory requirements than the default requirements.

At a next step 626, the new virtual machine is powered on. At a next step 628, the new virtual machine may employ a PXE boot to contact RDP server. In other words, the newly created virtual machine may broadcast a TFTP boot request packet. The boot request packet may include the newly created virtual machine MAC address and a request for boot instruction.

Upon receiving the TFTP boot request, at a next step 630, the RDP server may compare the MAC address against its list of MAC address. Upon recognizing the MAC address, the RDP server may begin sending boot information to the new virtual machine, at a next step 632. Upon receiving the boot information, the virtual machine may begin setting up its environment (e.g., parameters for the virtual machine, tools, operating system, applications for the designated role).

The remote method of creating a virtual machine provides many advantages. First, the human operator does not have to be physically in the same location as the potential host physical machine. Also, the decision of which physical machine to host the virtual machine is no longer dependent upon the knowledge of the human operator. Instead, the RDP server has the knowledge and intelligence to determine the best physical machine to host the new virtual machine. Further, the knowledge and skillset required to create a virtual machine with sufficient parameters to adequately perform its role may be pre-defined by experts. As a result, the human operator is no longer required to have the knowledge and/or skillset to create a new virtual machine.

As can be appreciated from embodiments of the invention, the computer-implemented method of remotely creating and managing virtual machines is a less labor-intensive method. Thus, a human operator is no longer required to individually access each virtual machine. Also, the ability to employ standard scripting to manage virtual machines removes the tedious and expensive task of creating different scripts to accommodate the different proprietary software. Further, new virtual machine may be created without being dependent upon the knowledge and skillset of a human operator, thereby, enabling the process to be automated and be remotely triggered. In addition, fewer errors may be encountered as dependency upon a human operator is removed. As a result, an automatic and remote method of creating and managing virtual machines may reduce cost and increase productivity.

While this invention has been described in terms of several embodiments, there are alterations, permutations, and equivalents, which fall within the scope of this invention. Also, the title, summary, and abstract are provided herein for convenience and should not be used to construe the scope of the claims herein. Further, in this application, a set of intermediate files or a set of any other item refers to one or more items in the set. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for remotely managing a virtual machine from a remote terminal, said virtual machine representing one of a plurality of virtual machines implemented on a hardware platform that is communicably coupled to said remote terminal via a computer network, each of said plurality of virtual machines being associated with a MAC (Media Access Controller) address of a plurality of MAC addresses associated with said hardware platform, said remotely managing being one of a wake action and a shut-down action, comprising:
receiving, using a network interface card (NIC) associated with said hardware platform, a management packet from said remote terminal, said management packet representing a data packet having therein at least a first MAC address, said management packet representing one of a wake packet for waking up said one of said plurality of virtual machines and a shut-down packet for shutting down a virtual machine that is associated with said first MAC address;
forwarding said management packet to a NIC manager that is executing on said hardware platform;
ascertaining, using said NIC manager, whether said first MAC address matches one of said plurality of MAC addresses associated with said hardware platform; and
if said first MAC address matches said one of said plurality of MAC addresses, performing one of said wake action and said shut-down action for said virtual machine that is associated with said first MAC address, said wake action being performed if said management packet represents said wake packet, said shut-down action being performed if said management packet represents said shut-down packet.

2. The method of claim 1 wherein said management packet represents said wake packet.

3. The method of claim 1 wherein said management packet represents said shut-down packet.

4. The method of claim 1 wherein said first MAC address is carried in a payload of said management packet.

5. The method of claim 1 wherein said management packet is identified as one of said wake packet and said shut-down packet using a value in a header of said management packet.

6. The method of claim 1 wherein said management packet is identified as one of said wake packet and said shut-down packet using a value carried in a payload of said management packet.

7. The method of claim 1 wherein said management packet represents an Ethernet packet.

8. The method of claim 1 wherein said management packet represents said shut-down packet, said method further comprising broadcasting said management packet to said plurality of virtual machines.

9. The method of claim 1 wherein said management packet represents said shut-down packet, said method further comprising ascertaining, using said NIC manager, from said management packet an identity of said virtual machine that is associated with said first MAC address and sending said management packet only to said virtual machine that is associated with said first MAC address.

10. A method for remotely creating a virtual machine from a remote terminal, said remote terminal being communicably coupled to a plurality of computers via a computer network, comprising:
receiving, using a network interface card (NIC) associated with a first one of said plurality of computers, a wake-up packet from said remote terminal, said wake-up packet representing a data packet having therein at least a first MAC address;
forwarding said management packet to a NIC manager that is executing on said first one of said plurality of computers;
ascertaining, using said NIC manager, whether said first MAC address matches one of a plurality of MAC addresses associated with said one of said plurality of computers; and
if said first MAC address matches said one of said plurality of MAC addresses and an already-created virtual machine that is associated with said first MAC address does not exist, employing an operating system of said first one of said plurality of computers to create said virtual machine in accordance with a virtual machine specification that is associated with at least one of said first MAC address and a sub-range of said plurality of MAC addresses.

11. The method of claim 10 further comprising powering on, if said first MAC address matches said one of said plurality of MAC addresses and an already-created virtual machine that is associated with said first MAC address already existed, said already-created virtual machine that is associated with said first MAC address using said operating system of said first one of said plurality of computers.

12. The method of claim 10 wherein said wake-up packet is generated at said remote terminal responsive to parameters input by a human operator.

13. The method of claim 12 wherein said parameters input by said human operator includes specifications for a virtual machine that said human operator wishes to create.

14. The method of claim 10 wherein said plurality of MAC addresses are divided into a plurality of sub-ranges, members in each of said plurality of sub-ranges having the same virtual machine specification.

15. The method of claim 10 wherein said first one of said plurality of computers is chosen by said remote terminal based on load-balancing.

16. The method of claim 10 wherein said first one of said plurality of computers is chosen by said remote terminal based on hardware resource availability.

17. The method of claim 10 further comprising
sending from said first one of said plurality of computers a boot request to said remote terminal, said sending said boot requested being performed after said virtual machine is created; and
receiving from said remote terminal at said first one of said plurality of computers boot instructions for booting up said virtual machine.

18. The method of claim 10 wherein said boot request includes said first MAC address.

19. The method of claim 10 wherein said first MAC address is chosen from a database of virtual machine MAC addresses to facilitate creating said management packet.

20. A method for remotely creating a virtual machine from a remote terminal, said remote terminal being communicably coupled to a plurality of computers via a computer network, comprising:
receiving, using a network interface card (NIC) associated with a first one of said plurality of computers, a wake-up packet from said remote terminal, said wake-up packet representing a data packet having therein at least a first MAC address;
forwarding said management packet to a NIC manager that is executing on said first one of said plurality of computers;
ascertaining, using said NIC manager, whether said first MAC address is found in one of a plurality of MAC address sub-ranges associated with said one of said plurality of computers; and
if said first MAC address is found in said one of a plurality of MAC address sub-ranges and an already-created virtual machine that is associated with said first MAC address does not exist, employing an operating system of said first one of said plurality of computers to create said virtual machine in accordance with a virtual machine specification that is associated with said one of a plurality of MAC address sub-ranges, wherein each of said plurality of MAC address sub-ranges is associated with a different virtual machine specification.

21. The method of claim 20 further comprising
sending from said first one of said plurality of computers a boot request to said remote terminal, said sending said boot requested being performed after said virtual machine is created; and
receiving from said remote terminal at said first one of said plurality of computers boot instructions for booting up said virtual machine.
